(19) United States
(12) Patent Application Publication
(10) Pub. No.: US 2026/0273316 A1
(43) Pub. Date: Sep. 17, 2026

(54) SELF-RETRACTING LIFELINE DEVICE WITH INTEGRATED RATCHET MECHANISM POWERED BY A CURRENT GENERATOR

(71) Applicant: Honeywell Safety Products USA, Inc., Charlotte, NC (US)

(72) Inventor: David Balandra Gomez, Benito Juarez CDMX (MX)

(21) Appl. No.: 19/078,964

(22) Filed: Mar. 13, 2025

(51) Int. Cl. A62B 35/00

(52) U.S. Cl. CPC A62B 35/0093

(57) ABSTRACT

A self-retracting lifeline (SRL) device is provided. For example, an SRL device comprises a housing, a rotatable axle, a lifeline wound around the axle such that extending the lifeline rotates the axle in a first rotational direction, a coil spring wound around the axle to provide a rotational biasing force to the axle in a second rotational direction opposite the first rotational direction such that the axle provides a retraction force to the lifeline, an electrical generator attached to the axle to generate electricity when the axle rotates, a ratchet wheel attached to the axle such that the ratchet wheel rotates when the axle rotates, a pawl having a pivoting proximal end, and an electrically activated actuator connected to a distal end of the pawl to pivot the pawl from a disengaged position to an engaged position when the generated electricity is above a threshold.

### FIELD OF THE INVENTION

Embodiments of the present disclosure generally relate to self-retracting devices, and, more particularly, to self-retracting lifeline devices.

### BACKGROUND

A self-retracting lifeline (SRL) device is a safety device that prevents falls by automatically locking when a worker falls. SRL devices are often used in industries where workers need to work at heights, such as construction. An SRL device is made up of a strap or cable wound up in a housing that is attached to an anchor point, with the strap or cable attached to a harness worn by a worker. When the worker moves around, the strap pays out and retracts as needed to enable the worker to readily move the work area around without restriction. However, if the worker falls, the device locks to prevent the strap from paying out and thereby limits the distance of the fall. Existing SRL devices have limited control over the arrest distance and the arrest force due to the design of their braking mechanisms.

. These limitations present technical challenges for SRL devices. Through applied effort, ingenuity, and innovation, the identified problem regarding control over arrest distance and arrest force have been addressed. The present disclosure provides a solution that improves control over these parameters, reducing the current control range and enabling finer adjustment. Embodiments of this solution are described in detail herein.

### BRIEF SUMMARY

Various embodiments described herein relate to self-retracting lifeline devices and associated methods of constructing a self-retracting lifeline devices.

A self-retracting lifeline (SRL) device is provided. For example, an SRL device comprises a housing defining an opening; a rotatable axle mounted within the housing; a lifeline at least partly wound around the axle and having a proximal end attached to the axle, at least a distal portion of the lifeline extending through the opening in the housing and positioned outside of the housing, wherein extending the lifeline rotates the axle in a first rotational direction; a coil spring wound around the axle to provide a rotational biasing force to the axle in a second rotational direction opposite the first rotational direction such that the axle provides a retraction force to the lifeline; an electrical generator attached to the axle such that the electrical generator generates electricity when the axle rotates, the generated electricity being proportional to a rotational speed of the axle; a ratchet wheel attached to the axle such that the ratchet wheel rotates when the axle rotates, the ratchet wheel having a main body and a plurality of teeth positioned around an outer edge of the main body of the ratchet wheel; a pawl having a proximal end pivotably affixed to a first stationary portion of the SRL device; and an electrically activated actuator connected to a distal end of the pawl and configured to pivot the pawl from a disengaged position to an engaged position when the generated electricity is above a threshold. When the pawl is in its disengaged position, the pawl does not contact the ratchet wheel. When the pawl is in its engaged position, the pawl engages with the ratchet wheel to stop rotation of the ratchet wheel in the first rotational direction and thereby stop rotation of the axle in the first rotational direction and stop extension of the lifeline.

In some embodiments, the electrical generator comprises a rotor and a stator. The rotor is attached to the axle such that the rotor rotates when the axle rotates. The rotor comprises a main body and a plurality of magnets positioned around an outer edge of the main body of the rotor. The stator is attached to a second stationary portion of the SRL device and positioned around the outer edge of the main body of the rotor. The stator comprises a main body and a plurality of electrical windings positioned around an inner edge of the main body of the stator such that rotation of the rotor induces an electrical current in the plurality of electrical windings.

In some embodiments, the actuator comprises a linear actuator with an axially movable piston movable between a retracted position in which the pawl is in the disengaged position and an extended position in which the pawl is in the engaged position.

In some embodiments, the piston has (i) a proximal end connected to a tension spring which applies a biasing force on the piston toward its retracted position and (ii) a distal end connected to the pawl.

In some embodiments, the threshold at which the actuator pivots the pawl from its disengaged position to its engaged position is when the generated electricity is sufficient to overcome the biasing force applied on the piston by the tension spring.

In some embodiments, the linear actuator comprises a solenoid.

In some embodiments, the actuator is affixed to the first stationary portion of the SRL device.

In some embodiments, the first stationary portion of the SRL device to which the pawl and the actuator are affixed is a first wall of the housing.

In some embodiments, the second stationary portion of the SRL device to which the stator is affixed is a second wall of the housing opposite the first wall of the housing.

In some embodiments, the lifeline comprises a strap or a cable.

In accordance with various embodiments of the present disclosure, a method of constructing a self-retracting lifeline is provided. In some embodiments, the method comprises mounting rotatable axle mounted within a housing defining an opening; attaching a proximal end of a lifeline to the axle; at least partly winding the lifeline around the axle such that unwinding the lifeline rotates the axle in a first rotational direction; extending at least a distal portion of the lifeline through the opening in the housing such that the distal portion of the lifeline is positioned outside of the housing; winding a coil spring around the axle to provide a rotational biasing force to the axle in a second rotational direction opposite the first rotational direction such that the axle provides a retraction force to the lifeline; attaching an electrical generator to the axle such that the electrical generator generates electricity when the axle rotates, the generated electricity being proportional to a rotational speed of the axle; attaching a ratchet wheel to the axle such that the ratchet wheel rotates when the axle rotates, the ratchet wheel having a main body and a plurality of teeth positioned around an outer edge of the main body of the ratchet wheel; pivotably affixing a proximal end of a pawl to a first stationary portion of the SRL device; electrically connecting an electrically activated actuator to the electrical generator to receive the generated electricity; and connecting the electrically activated actuator to a distal end of the pawl, the actuator configured to pivot the pawl from a disengaged position to an engaged position when the generated electricity is above a threshold. When the pawl is in its disengaged position, the pawl does not contact the ratchet wheel. When the pawl is in its engaged position, the pawl engages with the ratchet wheel to stop rotation of the ratchet wheel in the first rotational direction and thereby stop rotation of the axle in the first rotational direction and stop extension of the lifeline.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is a perspective view of an example SRL device in accordance with example embodiments of the present disclosure;

FIG. 2 is a perspective view of the example SRL device of FIG. 1 with a portion of its housing removed;

FIG. 3 is an exploded perspective view from the top and left of the example SRL device of FIG. 1 with a portion of its housing removed;

FIG. 4 is an exploded perspective view from the bottom and right of the example SRL device of FIG. 1 with a portion of its housing removed;

FIG. 5 is a perspective view of the locking mechanism of the example SRL device of FIG. 1, in a disengaged position;

FIG. 6 is a close-up the locking mechanism of the example SRL device of FIG. 1, in the disengaged position;

FIG. 7 is a perspective view of the locking mechanism of the example SRL device of FIG. 1, in an engaged position; and

FIG. 8 is a close-up the locking mechanism of the example SRL device of FIG. 1, in the engaged position.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” “bottom,” “left,” “right,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The phrases “in one example,” “according to one example,” “in some examples,” and the like generally mean that the particular feature, structure, or characteristic following the phrase may be included in at least one example of the present disclosure and may be included in more than one example of the present disclosure (importantly, such phrases do not necessarily refer to the same example).

If the specification states a component or feature “may,” “can,” “could,” “should,” “would,” “preferably,” “possibly,” “typically,” “optionally,” “for example,” “as an example,” “in some examples,” “often,” or “might” (or other such language) be included or have a characteristic, that specific component or feature is not required to be included or to have the characteristic. Such component or feature may be optionally included in some examples, or it may be excluded.

The word “example” or “exemplary” is used herein to mean “serving as an example, instance, or illustration.” Any implementation described herein as “example” or “exemplary” is not necessarily to be construed as preferred or advantageous over other implementations.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

The term “component” may refer to an article, a device, or an apparatus that may comprise one or more surfaces, portions, layers and/or elements. For example, an example component may comprise one or more substrates that may provide underlying layer(s) for the component and may comprise one or more elements that may form part of and/or are disposed on top of the substrate. In the present disclosure, the term “element” may refer to an article, a device, or an apparatus that may provide one or more functionalities.

Various embodiments of the present disclosure overcome the above technical challenges and difficulties and provide various technical improvements and advantages. For example, various embodiments of the present disclosure provide an example SRL device and an example method of constructing an SRL device.

Such an SRL device is often referred to simply as an SRL. To distinguish the overall device from the extendable/retractable strap, cable, etc. portion of the device, the overall device is referred to herein as an SRL device and the extendable/retractable strap, cable, etc. is referred to herein as a lifeline.

In various embodiments of the present disclosure, an SRL device comprises a current generator in connection with a drum hub of the SRL device. During a fall event, the current generator converts the rotational movement of the drum hub into electric current. The current generator is electrically connected to an electrically activated actuator, such as a solenoid, which is energized by the current generated by the current generator. When the drum hub rotates fast enough (e.g., during a fall) such that the current generated by the current generator is above a certain threshold, the electrically activated actuator is triggered and engages with a ratchet wheel to stop the rotation of the drum hub and thereby arrest the fall.

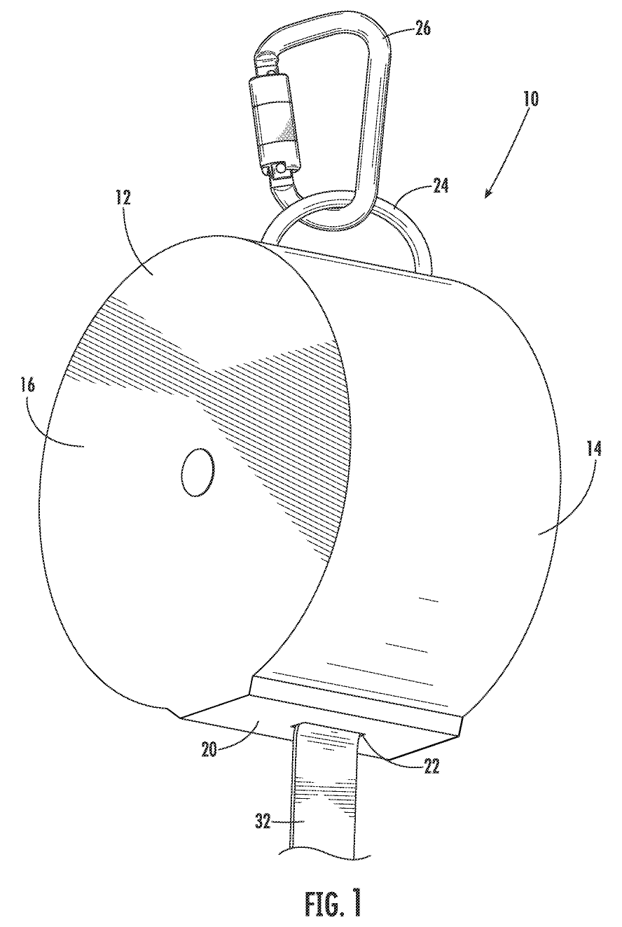

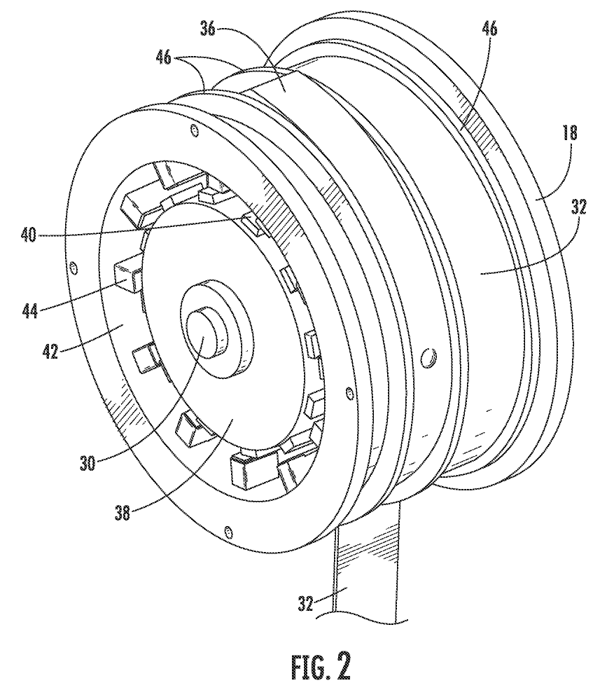

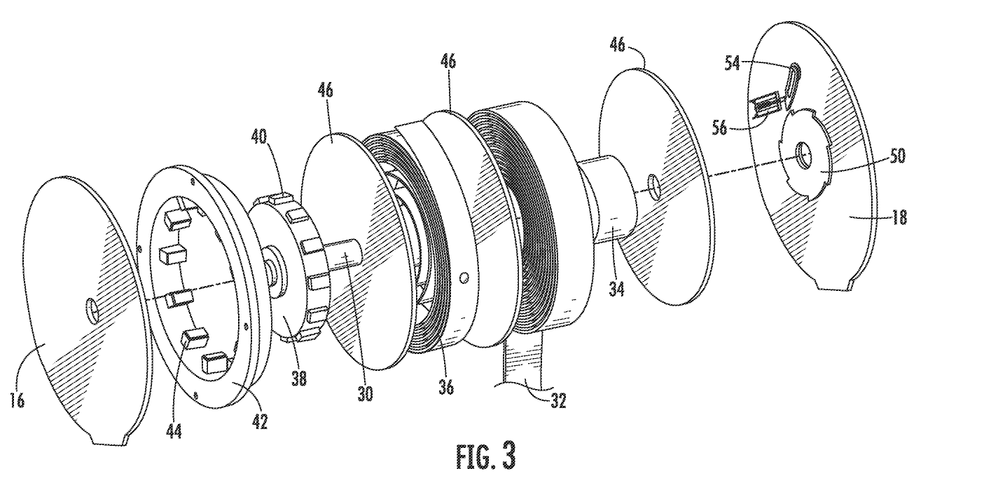

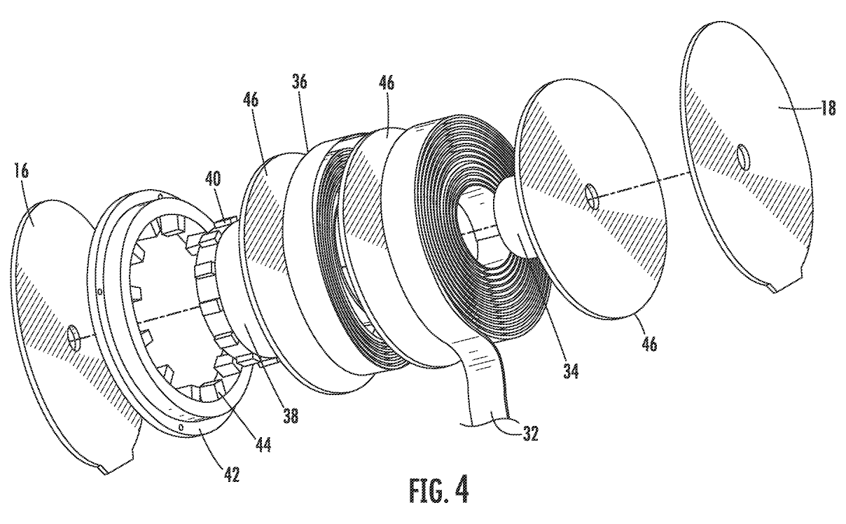

Referring now to FIGS. 1-8, an example SRL device is illustrated in accordance with example embodiments of the present disclosure. The SRL device 10 of FIGS. 1-8 comprises a generally cylindrical housing 12 to contain and protect the internal components, although any suitable shape may be used. The housing 12 comprises a generally cylindrical wall 14 that defines an internal chamber to contain the internal components, capped at opposing ends with a first generally circular wall 16 and a second generally circular wall 18. In the illustrated embodiment, a generally planar bottom wall 20 defines a slot or opening 22 through which a lifeline 32 extends.

In various embodiments, the lifeline may comprise any suitable elongated, flexible, and strong component that is suitable for use as a lifeline, such as but not limited to a nylon strap or a metal cable. The distal end of the lifeline 32 typically has an attachment point (not illustrated) to which an attachment device (e.g., a carabiner) (not illustrated) may be affixed. The attachment device is then attached to a harness or the like worn by a user to secure the user to the SRL device. Preferably, the SRL device incorporates means to absorb or dissipate the energy generated during a fall arrest. In one example, absorbing or dissipating this energy is performed by an external shock absorber (not illustrated) that is positioned between the distal end of the lifeline and the attachment point, although any other suitable means to absorb or dissipate the energy generated during a fall arrest may be used.

In use, the SRL device is attached to an anchor point. In the illustrated embodiment, the SRL device 10 has an attachment loop 24 to which an attachment device (e.g., a carabiner) 26 is attached. The attachment device 26 is then attached to the anchor point. When the user moves around, the lifeline pays out and retracts as needed to enable the user to readily move around without restriction. However, if the user falls, the SRL device locks, as described in detail below, to prevent the strap from paying out and thereby limits the distance of the fall.

In various embodiments, the SRL device 10 comprises a rotatable axle 30 (also termed a drum hub) rotatably mounted within the housing 12. In various embodiments, several components are attached to the axle 30. In various embodiments, some of the components attached to the axle 30 are separated by disc-like spacers 46 to maintain separation between the components.

In various embodiments, a proximal end (not visible) of the lifeline 32 is directly or indirectly attached to the axle 30 and the lifeline 32 is directly or indirectly at least partly wound around the axle 30. In the illustrated embodiment, the lifeline 32 is attached to and wound around an intermediate hub 34 which is in turn attached to the axle 30. As the lifeline 32 is extended from the housing, the axle 30 rotates in a first rotational direction. Using such an intermediate hub 34 for the lifeline provides, in effect, a gearing such that the radius of the intermediate hub 34 regulates how the rotational speed of the axle 30 translates into the linear speed of the lifeline 32. When the intermediate hub has a larger radius, it effectively means that for each complete rotation of the axle, more length of the lifeline is drawn out or retracted. Thus, while the worker's action determines the speed of rotation of the intermediate hub and the axle, the size of the intermediate hub directly affects how quickly the lifeline's length changes during that rotation.

In various embodiments, a coil spring 36 is wound around the axle 30. A proximal end (not visible) of the coil spring 36 is attached to the axle 30 and a distal end (not illustrated) of the coil spring 36 is attached to the housing 12. As the lifeline 32 is extended from the housing 12, a rotational biasing force to the axle 30 in a second rotational direction opposite the first rotational direction is generated by the coil spring 36 such that the axle 30 provides a retraction force to the lifeline 32.

In various embodiments, an electrical generator is attached to the axle 30 such that the electrical generator generates electricity when the axle 30 rotates. The amount of electricity generated is proportional to a rotational speed of the axle 30. In the illustrated embodiment, the electrical generator comprises a rotor 38 and a stator 42. The rotor 38 is attached to the axle 30 such that the rotor 38 rotates when the axle 30 rotates. The rotor 38 comprises a main body and a plurality of magnets 40 positioned around an outer edge of the main body of the rotor 38. Any suitable number, type, and placement of magnets may be used.

The stator 42 is attached to a stationary portion of the SRL device 10, such as to the first generally circular wall 16. The stator 42 comprises a main body with a plurality of electrical windings 44 positioned around an inner edge of the main body. The stator 42 is positioned such that the main body of the stator 42 surrounds the main body of the rotor 38, with a small amount of clearance between the windings 44 of the stator 42 and the magnets 40 of the rotor 38. This relative positioning of the stator 42 and the rotor 38 is such that rotation of the rotor 38 and therefore movement of the magnets 40 induces an electrical current in the windings 44 of the stator 42. Because the generated electricity is proportional to the rotational speed of the axle 30, a small amount of electricity is generated when the lifeline 32 is extended and retracted during normal operation. However, when the user falls, the lifeline 32 is extended much more quickly and therefore a larger amount of electricity is generated. As described further below, this larger amount of electricity is sufficient to trigger a braking mechanism in the SRL device 10 to arrest the fall. In various embodiments, a filtered half-wave rectifier (not illustrated) is used to ensure that current flows to the actuator only during the axle’s first direction of rotation while preventing any current flow when the axle rotates in the second opposite direction.

In various embodiments, the braking mechanism comprises a ratchet wheel 50, a pawl 54, and an electrically activated actuator 56 that causes the pawl 54 to engage the ratchet wheel 50 to stop extension of the lifeline 32 and thereby arrest a user’s fall. The ratchet wheel bis attached to the axle 30 such that the ratchet wheel 50 rotates when the axle 30 rotates and such that the axle 30 cannot rotate in the first direction when the braking mechanism is applied. The ratchet wheel 50 has a main body and a plurality of teeth 52 positioned around an outer edge of the main body. Any suitable number of teeth are used. The teeth are typically evenly spaced about the outer edge of the main body of the ratchet wheel 50. As illustrated, the teeth typically have an elongated curved face with a relatively low angle to the outer edge of the main body and a shorter face that is at a much steeper angle to the outer edge of the main body. The pawl 54 has a proximal end pivotably affixed to a stationary portion of the SRL device, such as the second wall 18, and a distal end that engages the ratchet wheel 50 when the electrically activated actuator 56 is actuated and the pawl 54 is rotated into an engaged position.

In various embodiments, the electrically activated actuator 56 comprises a linear actuator such as a solenoid. In the illustrated embodiment, the electrically activated actuator 56 comprises an axially movable piston 62 (also termed a plunger) and an electromagnetic coil 60 at least partly surrounding the piston 62 (only part of the electromagnetic coil 60 is illustrated for clarity). The electromagnetic coil 60 is electrically connected to the electrical windings 44 of the stator 42 via wires 58 (the wires 58 are truncated for simplicity). A proximal end of the piston 62 is attached to a tension spring 64 and a distal end of the piston 62 is attached to a distal end of the pawl 54.

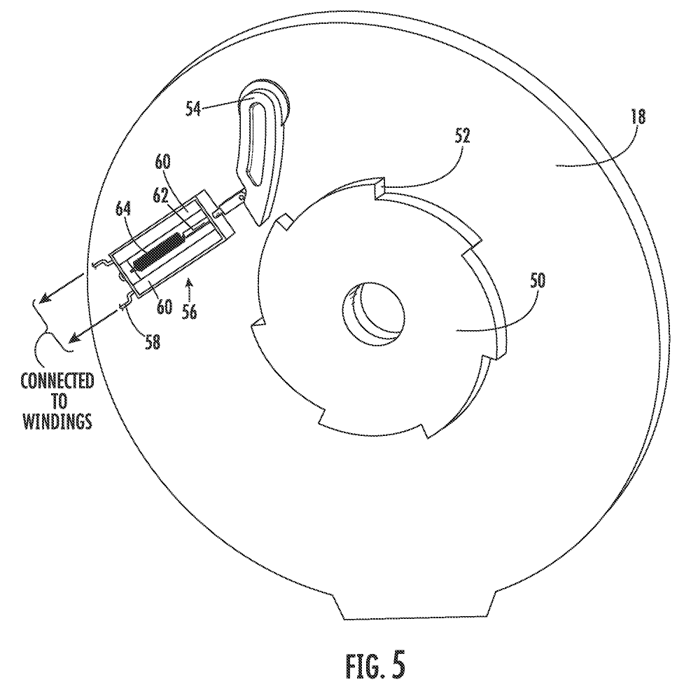

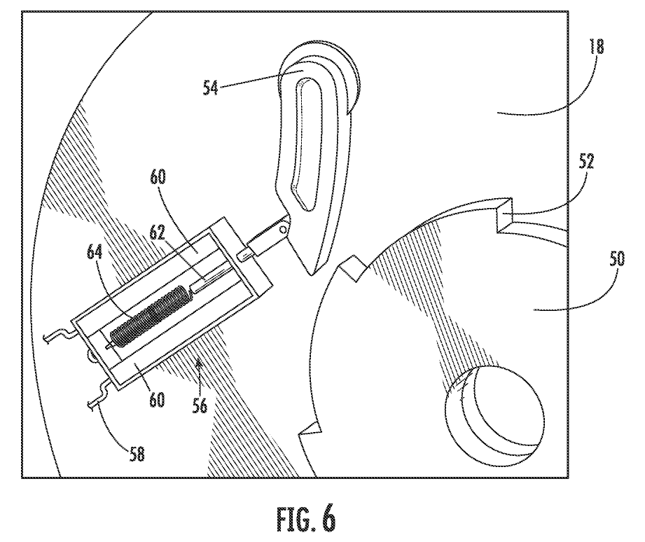

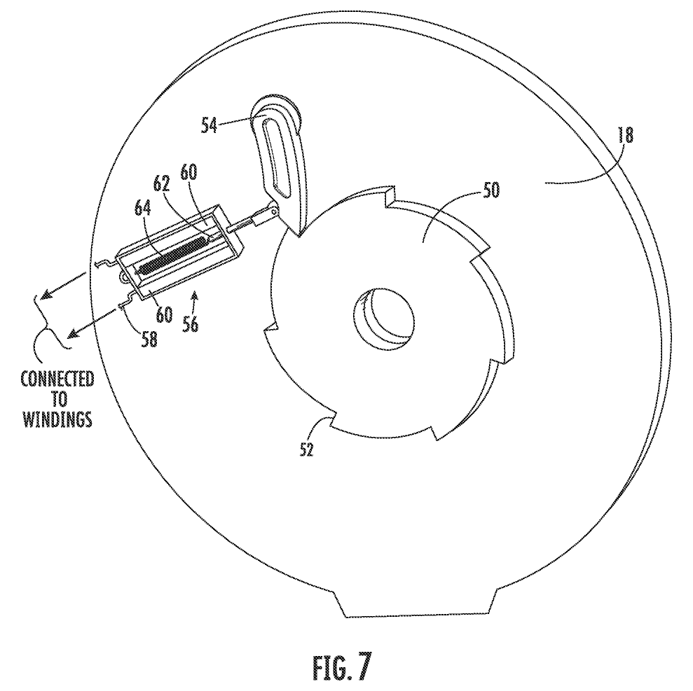

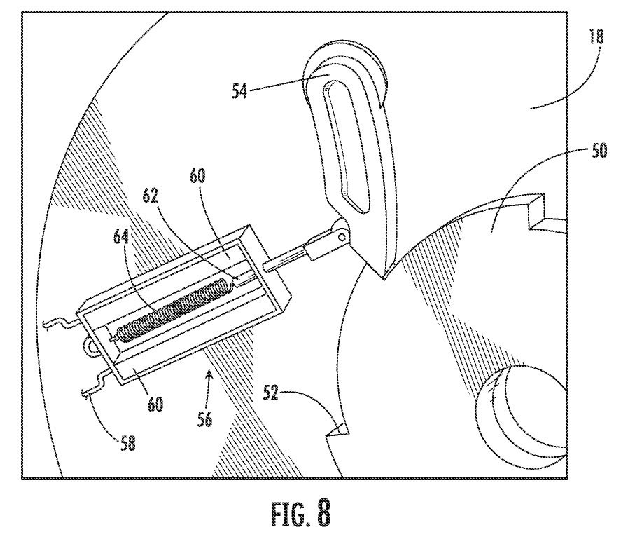

The piston 62 is axially movable between (i) a retracted position (illustrated in FIGS. 5 and 6) in which the pawl 54 is in its disengaged position and does not contact the ratchet wheel 50 and (ii) an extended position (illustrated in FIG. 7 and 8) in which the pawl 54 is in its engaged position. The tension spring 64 applies a biasing force on the piston 62 towards its retracted position. Applying an electric current to the electromagnetic coil 60 causes the electromagnetic coil 60 to apply a longitudinal force to the piston 62 to move (or attempt to move) the piston 62 from its retracted position to its extended position. Due to the biasing force applied by the tension spring 64 on the piston 62, the force applied by the electromagnetic coil 60 on the piston 62 only causes the piston 62 to move from its retracted position to its extended position if the force applied by the electromagnetic coil 60 on the piston 62 overcomes the biasing force applied by the tension spring 64 to the piston 62.

As described above, a small amount of electricity is generated in the windings 44 by the rotation of the rotor 38 when the lifeline 32 is extended and retracted during normal operation, but a larger amount of electricity is generated when a user falls due to the faster rotation of the axle 30 and therefore the rotor 38. In various embodiments, the rotor 38 (including the magnets 40), the stator 42 (including the windings 44), and the electrically activated actuator 56 (including, in particular, the tension spring 64) are all designed/selected to ensure proper operation of the SRL device 10. Specifically, in various embodiments, the components are designed/selected such that the smaller amount of electricity generated during normal operation of the SRL device 10 is not sufficient for the force applied by the electromagnetic coil 60 on the piston 62 to overcome the biasing force applied by the tension spring 64 to the piston 62, such that the piston 62 does not move from its retracted position to its extended position. However, in various embodiments, the components are designed/selected such that the larger amount of electricity generated during a fall is sufficient for the force applied by the electromagnetic coil 60 on the piston 62 to overcome the biasing force applied by the tension spring 64 to the piston 62, such that the piston 62 moves from its retracted position to its extended position. As such, this larger amount of electricity is sufficient to rotate the pawl 54 from its disengaged position to its engaged position. When the pawl 54 is in its engaged position, the distal end of the pawl 54 contacts the ratchet wheel 50 and engages one of the teeth of the ratchet wheel 50, thereby preventing the ratchet wheel 50 from rotating in the first rotational direction and stopping rotation of the axle in the first rotational direction and stopping extension of the lifeline 32, thereby arresting the user’s fall.

In various embodiments, when a fall is arrested the rotation of the electrical generator stops, thereby halting the electric current flow. As a result, the electrically activated actuator ceases applying the biasing force on the piston, allowing the spring to attempt to return the piston to its disengaged position. However, because the worker’s weight (including tools, harness, and clothing) is applied at the attachment point of the lifeline, the force exerted by the spring on the piston and pawl becomes negligible. The ratchet wheel prevents the pawl from returning to its disengaged position, thereby ensuring that the worker remains in a stable position after the fall arrest, even in the absence of an electric current.

While the description above provides an example SRL device 10, it is noted that the scope of the present disclosure is not limited to the description above. In some examples, an example SRL device 10 in accordance with the present disclosure may be in other forms. In some examples, an example SRL device 10 may comprise one or more additional and/or alternative elements, and/or may be structured differently than that illustrated in FIGS. 1-8.

While various embodiments in accordance with the principles disclosed herein have been shown and described above, modifications thereof may be made by one skilled in the art without departing from the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present disclosure. Furthermore, any advantages and features described above may relate to specific embodiments but shall not limit the application of such issued claims to processes and structures accomplishing any or all of the above advantages or having any or all of the above features.

In addition, the section headings used herein are provided for consistency with the suggestions under 37 C.F.R. § 1.77 or to otherwise provide organizational cues. These headings shall not limit or characterize the disclosure set out in any claims that may issue from this disclosure. For instance, a description of a technology in the "Background" is not to be construed as an admission that certain technology is prior art to any disclosure in this disclosure. Neither is the "Summary" to be considered as a limiting characterization of the disclosure set forth in issued claims. Furthermore, any reference in this disclosure to "disclosure" or "embodiment" in the singular should not be used to argue that there is only a single point of novelty in this disclosure. Multiple embodiments of the present disclosure may be set forth according to the limitations of the multiple claims issuing from this disclosure, and such claims accordingly define the disclosure, and their equivalents, which are protected thereby. In all instances, the scope of the claims shall be considered on their own merits in light of this disclosure but should not be constrained by the headings set forth herein.

Also, systems, subsystems, apparatuses, techniques, and methods described and illustrated in the various embodiments as discrete or separate may be combined or integrated with other systems, modules, techniques, or methods without departing from the scope of the present disclosure. Other devices or components shown or discussed as coupled to, or in communication with, each other may be indirectly coupled through some intermediate device or component, whether electrically, mechanically, or otherwise. Other examples of changes, substitutions, and alterations are ascertainable by one skilled in the art and could be made without departing from the scope disclosed herein.

Many modifications and other embodiments of the disclosure set forth herein will come to mind to one skilled in the art to which these embodiments pertain having the benefit of teachings presented in the foregoing descriptions and the associated figures. Although the figures only show certain components of the apparatuses and systems described herein, various other components may be used in conjunction with the components and structures disclosed herein. Therefore, it is to be understood that the disclosure is not to be limited to the specific embodiments disclosed and that modifications and other embodiments are intended to be included within the scope of the appended claims. For example, the various elements or components may be combined, rearranged, or integrated in another system or certain features may be omitted or not implemented. Moreover, the steps in any method described above may not necessarily occur in the order depicted in the accompanying drawings, and in some cases one or more of the steps depicted may occur substantially simultaneously, or additional steps may be involved. Although specific terms are employed herein, they are used in a generic and descriptive sense only and not for purposes of limitation.

What is claimed is:

1. A self-retracting lifeline (SRL) device comprising:
a housing defining an opening;
a rotatable axle mounted within the housing;
a lifeline at least partly wound around the axle and having a proximal end attached to the axle, at least a distal portion of the lifeline extending through the opening in the housing and positioned outside of the housing, wherein extending the lifeline rotates the axle in a first rotational direction;
a coil spring wound around the axle to provide a rotational biasing force to the axle in a second rotational direction opposite the first rotational direction such that the axle provides a retraction force to the lifeline;
an electrical generator attached to the axle such that the electrical generator generates electricity when the axle rotates, the generated electricity being proportional to a rotational speed of the axle;
a ratchet wheel attached to the axle such that the ratchet wheel rotates when the axle rotates, the ratchet wheel having a main body and a plurality of teeth positioned around an outer edge of the main body of the ratchet wheel;
a pawl having a proximal end pivotably affixed to a first stationary portion of the SRL device; and
an electrically activated actuator configured to receive the generated electricity from the electrical generator and connected to a distal end of the pawl and configured to pivot the pawl from a disengaged position to an engaged position when the generated electricity is above a threshold;
wherein, when the pawl is in its disengaged position, the pawl does not contact the ratchet wheel; and
wherein, when the pawl is in its engaged position, the pawl engages with the ratchet wheel to stop rotation of the ratchet wheel in the first rotational direction and thereby stop rotation of the axle in the first rotational direction and stop extension of the lifeline.

2. The SRL device of claim 1, wherein the electrical generator comprises:
a rotor attached to the axle such that the rotor rotates when the axle rotates, the rotor comprising a main body and a plurality of magnets positioned around an outer edge of the main body of the rotor; and
a stator attached to a second stationary portion of the SRL device and positioned around the outer edge of the main body of the rotor, the stator comprising a main body and a plurality of electrical windings positioned around an inner edge of the main body of the stator such that rotation of the rotor induces an electrical current in the plurality of electrical windings.

3. The SRL device of claim 2, wherein the actuator comprises a linear actuator with an axially movable piston movable between a retracted position in which the pawl is in the disengaged position and an extended position in which the pawl is in the engaged position.

4. The SRL device of claim 3, wherein the piston has (i) a proximal end connected to a tension spring which applies a biasing force on the piston toward its retracted position and (ii) a distal end connected to the pawl.

5. The SRL device of claim 4, wherein the threshold at which the actuator pivots the pawl from its disengaged position to its engaged position is when the generated electricity is sufficient to overcome the biasing force applied on the piston by the tension spring.

6. The SRL device of claim 3, wherein the linear actuator comprises a solenoid.

7. The SRL device of claim 2, wherein the actuator is affixed to the first stationary portion of the SRL device.

8. The SRL device of claim 7, wherein the first stationary portion of the SRL device to which the pawl and the actuator are affixed is a first wall of the housing.

9. The SRL device of claim 8, wherein the second stationary portion of the SRL device to which the stator is affixed is a second wall of the housing opposite the first wall of the housing.

10. The SRL device of claim 1, wherein the lifeline comprises a strap or a cable.

11. A method of constructing a self-retracting lifeline (SRL) device, the method comprising:
mounting rotatable axle mounted within a housing defining an opening;
attaching a proximal end of a lifeline to the axle;
at least partly winding the lifeline around the axle such that unwinding the lifeline rotates the axle in a first rotational direction;
extending at least a distal portion of the lifeline through the opening in the housing such that the distal portion of the lifeline is positioned outside of the housing;
winding a coil spring around the axle to provide a rotational biasing force to the axle in a second rotational direction opposite the first rotational direction such that the axle provides a retraction force to the lifeline;
attaching an electrical generator to the axle such that the electrical generator generates electricity when the axle rotates, the generated electricity being proportional to a rotational speed of the axle;
attaching a ratchet wheel to the axle such that the ratchet wheel rotates when the axle rotates, the ratchet wheel having a main body and a plurality of teeth positioned around an outer edge of the main body of the ratchet wheel;
pivotably affixing a proximal end of a pawl to a first stationary portion of the SRL device;
electrically connecting an electrically activated actuator to the electrical generator to receive the generated electricity; and
connecting the electrically activated actuator to a distal end of the pawl, the actuator configured to pivot the pawl from a disengaged position to an engaged position when the generated electricity is above a threshold;
wherein, when the pawl is in its disengaged position, the pawl does not contact the ratchet wheel; and
wherein, when the pawl is in its engaged position, the pawl engages with the ratchet wheel to stop rotation of the ratchet wheel in the first rotational direction and thereby stop rotation of the axle in the first rotational direction and stop extension of the lifeline.

12. The method of claim 11, wherein the electrical generator comprises:
a rotor attached to the axle such that the rotor rotates when the axle rotates, the rotor comprising a main body and a plurality of magnets positioned around an outer edge of the main body of the rotor; and
a stator attached to a second stationary portion of the SRL device and positioned around the outer edge of the main body of the rotor, the stator comprising a main body and a plurality of electrical windings positioned around an inner edge of the main body of the stator such that rotation of the rotor induces an electrical current in the plurality of electrical windings.

13. The method of claim 12, wherein the actuator comprises a linear actuator with an axially movable piston movable between a retracted position in which the pawl is in the disengaged position and an extended position in which the pawl is in the engaged position.

14. The method of claim 13, wherein the piston has (i) a proximal end connected to a tension spring which applies a biasing force on the piston toward its retracted position and (ii) a distal end connected to the pawl.

15. The method of claim 14, wherein the threshold at which the actuator pivots the pawl from its disengaged position to its engaged position is when the generated electricity is sufficient to overcome the biasing force applied on the piston by the tension spring.

16. The method of claim 13, wherein the linear actuator comprises a solenoid.

17. The method of claim 12, wherein the actuator is affixed to the first stationary portion of the SRL device.

18. The method of claim 17, wherein the first stationary portion of the SRL device to which the pawl and the actuator are affixed is a first wall of the housing.

19. The method of claim 18, wherein the second stationary portion of the SRL device to which the stator is affixed is a second wall of the housing opposite the first wall of the housing.

20. The method of claim 11, wherein the lifeline comprises a strap or a cable.
